(19) United States
(12) Patent Application Publication
(10) Pub. No.: US 2003/0185389 A1
(43) Pub. Date: Oct. 2, 2003

(54) Telephone handset shoulder rest

(76) Inventor: Alan J. Wheatley, Draper, UT (US)

Correspondence Address: THORPE NORTH WESTERN, 8180 SOUTH 700 EAST, SUITE 200, P.O. BOX 1219, SANDY, UT, 84070, US

(21) Appl. No.: 10/396,919

(22) Filed: Mar. 24, 2003

Related U.S. Application Data
(60) Provisional application No. 60/367,856, filed on Mar. 26, 2002.

(51) Int. Cl. H04M 1/00

(52) U.S. Cl. 379/449

(57) ABSTRACT

A telephone handset shoulder rest device (10) and method to facilitate holding a telephone handset (14) between a user's head and shoulder includes a spacing member (18) disposed on a back of the telephone handset. The spacing member is sized to facilitate holding the telephone handset between the user's head and shoulder, and includes a cushion (30) formed of a compliant material. The compliant material can include a gel material (38). The spacing member can include an outer skin of TPU, and an interior of PU. A portion (44) of the spacing member can be at least translucent, or transparent. Indicia (48) can be disposed behind the portion of the spacing member, and can visible therethrough. The indicia can include art work, a logo, an advertisement, an instruction, a brand, and/or a trademark. The spacing member can include a bulbous portion that alters a visual appearance of the indicia.

This application claims the benefit of U.S. Provisional Patent Application No. 60/367,856, filed Mar. 26, 2002.

### BACKGROUND OF THE INVENTION

1. Field of the Invention

The present invention relates generally to a telephone handset shoulder rest that attaches to the back of a telephone handset to allow hands-free holding of the telephone handset between a user's shoulder and head.

2. Related Art

Telephone shoulder rests have been developed to allow a telephone user to hold a telephone receiver between his or her head and shoulder, in a hands-free manner. Such a phone shoulder rest allows the user to talk on the telephone while using his or her hands, such as to write or type. Examples of such telephone shoulder rests are shown in U.S. Pat. Nos. 2,243,554; 3,567,871; 4,759,058; D278,057; D308,062; D323,829; D350,356; D453,017; D449,043 and D449,83 1. Typical telephone shoulder rests utilize a foam material for comfort.

Some telephone shoulder rests have been developed that provide telephone numbers thereon. Examples of such telephone shoulder rests are shown in U.S. Pat. Nos. 2,762,868 and 4,817,139. Such telephone shoulder rests, however, are rigid or hard. For example, U.S. Pat. No. 4,817,139 shows a wire and a picture frame. As another example, U.S. Pat. No. 2,762,868 shows a tubular member between flat sections.

While headsets (ear or head mounted earphone and/or microphone) are often used by people who speak on the phone for extended periods of time, such as telemarketers, many people prefer using typical telephone receivers.

### SUMMARY OF THE INVENTION

It has been recognized that thousands of people utilize telephones and spend several hours a day in the vicinity of such telephones, such as in the workplace. In addition, it has been recognize that it would be advantageous to utilize the telephone and its position in front of people to advertise, promote, and/or inform. In addition, it has been recognized that it would be advantageous to improve the comfort of telephone shoulder rests.

The invention provides a telephone handset shoulder rest device to facilitate holding the telephone handset between a user's head and shoulder. A spacing member is disposed on a back of the telephone handset, and is sized to facilitate holding the telephone handset between the user's head and shoulder. An enlarged portion forms at least a portion of an end of the spacing member, and has a thickness with respect to the telephone handset greater than another portion of the spacing member. A cushion forms at least a portion of the spacing member.

In accordance with a more detailed aspect of the present invention, the cushion can be formed of a compliant material, such as a gel material.

In accordance with another more detailed aspect of the present invention, the spacing member can include a translucent portion that is at least translucent. Indicia can be disposed behind the translucent portion of the spacing member, and visible through the translucent portion of the spacing member. The indicia can include art work, a logo, an advertisement, an instruction, a brand, a trademark, etc.

In accordance with another more detailed aspect of the present invention, the device can include a pair of at least semi-bulbous portions that forming at least a portion of opposite ends of the spacing member. The ends can have substantially equal widths. A narrower neck can form a portion of the spacing member between the pair of at least semi-bulbous portions. The narrower neck can have a width less than the substantially equal widths of the pair of at least semi-bulbous portions. In addition, the narrower neck can have a thickness less than a thickness of the pair of at least semi-bulbous portions.

In accordance with another more detailed aspect of the present invention, the spacing member can include a base with the cushion being disposed thereon. The base can be disposed on the back of the telephone handset. The base can be relatively more rigid with respect to the cushion, and the cushion can be relatively more flexible with respect to the base.

In accordance with another more detailed aspect of the present invention, the cushion can includes an outer skin of thermo plastic urethane, and an interior of polyurethane.

In accordance with another more detailed aspect of the present invention, the enlarged portion is at least semi-bulbous and corresponds to the translucent portion to alter a visual appearance of the indicia.

In accordance with another more detailed aspect of the present invention, the spacing member can include a base that has one end thicker than another. In addition, the base can have a back surface that is arcuate.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a top view of a telephone handset shoulder rest in accordance with an embodiment of the present invention;

FIG. 2 is a side view of the telephone handset shoulder rest of FIG. 1;

FIG. 3 is an end view of the telephone handset shoulder rest of FIG. 1;

FIG. 4 is a cross-sectional side view of the telephone handset shoulder rest of FIG. 1;

FIG. 5 is a top view of a telephone handset shoulder rest in accordance with an embodiment of the present invention;

FIG. 6 is a side view of the telephone handset shoulder rest of FIG. 5;

FIG. 7 is an end view of the telephone handset shoulder rest of FIG. 5;

FIG. 8 is a cross-sectional side view of the telephone handset shoulder rest of FIG. 5;

FIG. 9 is a perspective view of the telephone handset shoulder rest of FIG. 5, shown disposed on a telephone handset; and

FIG. 10 is a perspective view of the telephone handset shoulder rest of FIG. 5, shown disposed on a telephone handset, and held between a user's head and shoulder.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

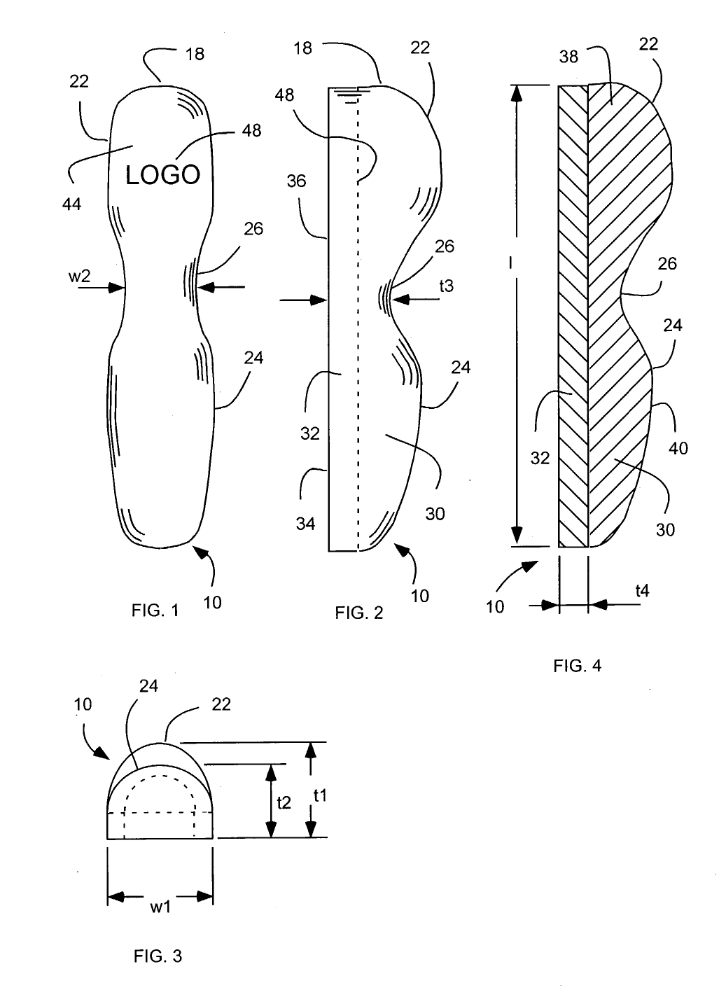

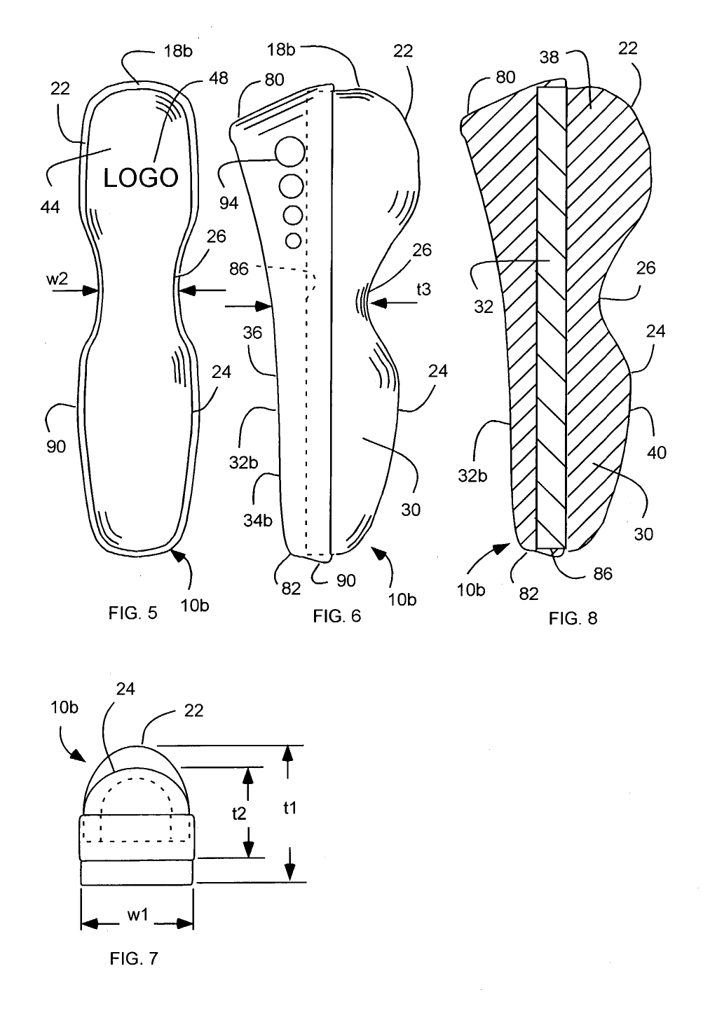

As illustrated in FIGS. 1-4, a telephone handset shoulder rest device, indicated generally at 10, in accordance with the present invention is shown to facilitate holding a telephone handset 14 between a user's head 15 and shoulder 16 in a hands-free manner, as shown in FIG. 10, and to provide advertisement, promotion, information, etc. It will be appreciated that the telephone occupies a prominent place in millions of households and businesses. Many people spend a significant amount of time on the telephone every day. In addition, many people reach for the telephone, at home and at work, several times a day. Furthermore, many people spend several hours a day at a desk, and in front of a telephone. It has been recognized that the location and prominence of the telephone can be utilized for advertisement, promotion, information, etc. In addition, it has been recognized that many people hold the phone between their head and shoulder in a hands-free manner. Therefore, the device 10 of the present invention acts as both a telephone handset shoulder rest, and a device to advertise, promote, inform, etc. The telephone handset 14 can be a typical receiver wired to a base, a cordless receiver in remote operation with a base, a cordless phone, a cell phone, etc.

The telephone handset shoulder rest device 10 is affixed to a back or back surface of the telephone handset 14, as shown in FIG. 9. The device 10 includes a spacing member 18 sized to facilitate holding the telephone handset 14 between a user's head and shoulder, and to increase a thickness of the handset, and to fill more of the space between the user's head and shoulder. It will be appreciated that increasing the thickness of the handset with the spacing member requires less movement between the user's head and shoulder to grip the handset. In addition, it will be appreciated that many modern handsets have become increasingly thinner, making them more difficult to hold between the head and shoulder. The spacing member 18 can have a height or a thickness t1 and/or t2 that together with a thickness of the handset fill more of the space between the user's head and shoulder to facilitate holding the handset in a hands-free manner. Thus, the spacing member can have a thickness t1 and/or t2 between approximately ¾ to two (0.75-2) inches.

In addition, the device 10 or spacing member 18 can be sized and shaped to comfortably conform to the user's shoulder. The device 10 or spacing member 18 can have opposite ends or portions 22 and 24, such as upper and lower end or portions, that are thicker and/or wider, and a middle section 26 that is narrower and/or thinner. For example, the opposite ends 22 and 24 can have a greater thickness t1 and t2 than the thickness t3 of the middle section 26. Similarly, the opposite ends 22 and 24 can have a greater width w1 than the width w2 of the middle section 26. Thus, the device 10 or spacing member 18 can have somewhat of an hourglass shape. The narrowed and/or thinner middle section 26, and the enlarged ends 22 and 24, facilitate engagement with the user's shoulder. For example, the user's shoulder 16 can be received, in or nest in, an indentation created at the middle section, with the ends 22 and 24 straddling the user's shoulder 16, to maintain the device 10, and thus the handset 14, on the user's shoulder 16.

The opposite ends 22 and 24 can have a bulbous or semi-bulbous shape or can form a bulbous or semi-bulbous portion. The side and top surfaces or walls can have a broad curvature or broadly curving interface or transition. Similarly, a transition between the opposite ends 22 and 24 and the middle section 26 can be broadly curved. Thus, the middle section 26 provides a tapering neck between the bulbous ends. The broad curves and bulbous shape provide comfort while providing a nesting indentation for the user's shoulder. The term “bulbous” as used herein refers to a curved, round, or sphere-like shape. The term “semi-bulbous” as used herein refers to a shape that is only partially bulbous, for example, with only the upper side or facing side of the opposite ends 22 and 24 being bulbous while the lower side is flat to attach to the handset. The middle section 26 can form a narrower neck between the bulbous shape of the opposite ends 22 and 24.

The upper end or portion 22 can be larger, or can form an enlarged portion, with respect to the rest of the device 10 or spacing member 18, or with respect to the middle section 26 and lower end or portion 24. For example, the thickness t1 of the upper end 22 can be greater than the thickness t2 of the lower end 24, and greater than the thickness t3 of the middle section 26. It will be appreciated that the handset 14 is angled with respect to the user's head 15 during use, and thus is angled with respect to the user's shoulder 16 during use. Thus, the enlarged portion or upper end 22 can abut to the user's shoulder 16 and resist the device 10 and handset 14 from sliding off the user's shoulder during use.

The lower end or portion 24 can be longer, or can form an elongated portion, with respect to the rest of the device 10 or spacing member 18, or with respect to the middle section 26 and the upper end or portion 22. For example, the length of the lower end or portion 24 can be greater than a length of the middle section 26, and greater than a length of the upper end or section 24. The elongated portion can extend down the handset 14 and down the user's shoulder to further support the handset and cushion the user's shoulder.

In addition, the device 10 or spacing member 18 can be sized and shaped to fit to the handset 14. Thus, the device 10 or spacing member 18 can have a width w and a length l sized to fit on most standard handsets. For example, the spacing member 18 can have a width w between approximately 1 and 1½ (1-1.5) inches, and a length 1 between approximately 4-7 inches. In one aspect, the upper and lower ends or portions 22 and 24 can have substantially the same or equal width w1. Thus, the device 10 or spacing member can have a greater surface area for affixing to the handset.

Furthermore, the spacing member 18 can include a cushion 30 formed of a compliant material for added comfort during use. The cushion 30 can be disposed on a base 32, which is disposed on or affixed to the handset 14. The base 32 can be more rigid, or relatively rigid, with respect to the cushion 30, while the cushion 30 is more flexible, or relatively flexible, with respect to the base 32. The base 32 also can be flexible enough to bend or match the contour or curvature of the handset. Thus, the base can be rigid enough to support the cushion, but flexible enough to conform to the handset. The base 32 or spacing member 18 can include a back surface 34 with an adhesive layer 36 thereon to affix or secure the device 10 to a back of the handset 14. The device 10 can be initially provided with a removable backing layer disposed over the adhesive layer 36, which can be removed to affix the device to the handset. The adhesive layer 36 is one example of an affixing means for affixing the spacing member or base to the handset. Other affixing means can be used, including for example, hook-and-loop type fasteners, glue, double sided tape, a tacky material, clips, screws, rivets, bands or straps extending around the handset, etc.

The compliant material of the cushion 30 advantageously can be a gel 38, such as silicon, diffused polyurethane, etc. In addition, the spacing member 18 or cushion 30 can include an outer skin 40 surrounding the gel 38. The skin 40 can include a thermo plastic urethane (TPU) and can surround polyurethane (PU). Alternatively, the spacing member can be of any appropriate material, such as water, silicon, etc. As stated above, the base 32 can be more rigid, and can include a polyvinyl chloride (PVC) material. The skin 40 can be attached to a perimeter of the base 32 to enclose the gel between the skin and the base.

The spacing member 18 or cushion 30 advantageously can have a translucent portion 44 that is at least translucent. In one aspect, the entire cushion 30 or the entire upper portion of the spacing member 18 can be translucent. In another aspect, the translucent portion can be substantially transparent or clear. The cushion material, or gel 38, can be substantially transparent, or at least translucent. Similarly, the skin 40 can be substantially transparent. In addition, the base 32 can be transparent or translucent. Furthermore, the base 32 can be colored and can be translucent to impart a color appearance to the spacing member.

Indicia 48 advantageously can be disposed behind the translucent portion 44 of the spacing member 18 or cushion 30, and visible therethrough. The indicia 48 can be disposed on an upper surface of the base 32, or between the cushion 30 or gel 38 and the base 32. Thus, the translucent portion 44 can protect the indicia 48 from wear. In addition, the use of a translucent or transparent gel material also provides a unique visual appearance. The indicia can include art work, a logo, an advertisement, an instruction, a brand, a trademark, etc.

The indicia 48 can be printed on a card or the like that is inserted between the base 32 and the spacing member 18 or gel material. In addition, the indicia 48 can be printed on the front surface of the base 32. In one aspect, the indicia 38 advantageously can be provided on a clear or transparent sheet. Such a transparent sheet gives the appearance that the indicia is floating in the spacing member 18 or cushion.

The bulbous shape of the ends 22 and 24 can alter a visual appearance of the indicia 48. For example, the bulbous shape can impart a magnifying glass illusion. In addition, the cushion 30 or gel 38 can be flexible, thus dynamically altering a visual appearance of the indicia 48 as the cushion 30 or gel 38 is compressed and relaxed.

The device 10 or spacing member 18 can be formed by the base 32 and the cushion 30. The base 32 can have a thickness t4 between approximately ⅛ to ½ inches. The thickness t4 of the base 32 can reduce the required cushion material or gel.

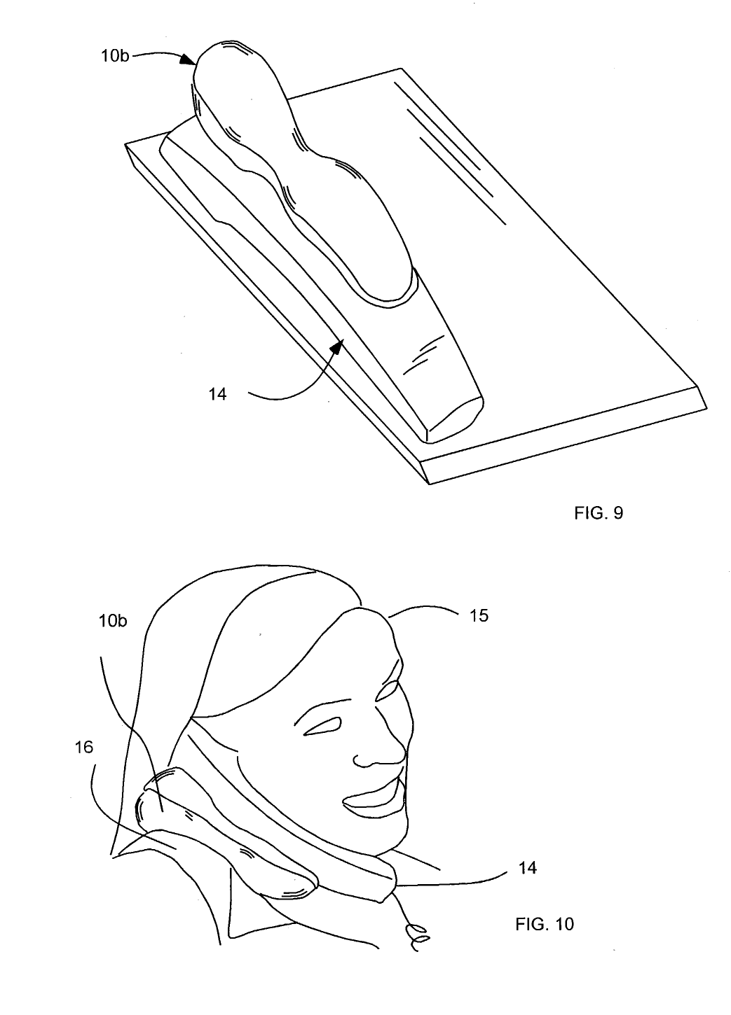

Referring to FIGS. 5-8, another telephone handset shoulder rest device 10b is shown that is similar in many respects to that described above. The device 10b can include a spacing member 18b that includes a base 32band a cushion 30. The base 32b can be angled or inclined, or that has a wedge shape, with a thicker upper end 80 and a thinner lower end 82. The wedge shape of the base 32b can provide a thicker spacing member 18b, and can provide the handset 14 at a desired angle. In addition, the thicker base 32b can also help fill the space between the user's head and shoulder 15 and 16 while reducing the amount of cushion material or gel 38. Furthermore, the base 32b can have a back surface 34b that is curved or arcuate to better match a typical handset.

In addition, the base 32b can include a cavity or indentation 86 that receives and holds the cushion 30. A portion of the cushion, or the base 32 as described above, can be disposed in the cavity 86. A perimeter wall 90 can extend from the base 32b and extend around a perimeter of the cavity 86, and thus around a perimeter of the cushion 30. The wall 90 can assist holding the skin 40, such as against the base 32 as described above, and can resist tampering or inadvertent peeling of the skin 40. The wall 90 can be affixed or adhered to the skin.

The base 32b can be flexible to form or match the contour of the handset, but can be more rigid, or relatively rigid, with respect to the cushion 30. The base 32b can be formed of or can include a polyvinyl chloride (PVC) material. In addition, the base 32b can be at least translucent, or even transparent.

Protrusions and/or indentations 94 can be formed on opposite sides of the device 10b or base 32b to facilitate griping. It will be appreciated that a user may reach for the handset 14 and purposefully or inadvertently grasp the device 32b. Thus, the protrusions and/or indentations 94 facilitate holding the device 32b, and resist the handset 14 from inadvertently slipping from the user's hand. The protrusions and/or indentations 94 can be of any appropriate size or shape.

The telephone handset shoulder rest device 10 or 10b can be utilized to simultaneously facilitate holding a handset, and promote products or provide information. The telephone handset shoulder rest 10 or 10b, as described above, can be provided. The indicia 48 can be provided under the translucent portion that is indicative of the promotion or information. The indicia 48 can include art work, a logo or trademark for a product, service, business, etc. Instructions can be provided to affix the device to the handset. Alternatively, the device can be provided already affixed to the handset. Such telephone handset shoulder rest devices 10 or 10bcan be given away as promotional items. Users can then install the device 10 or 10b on their phones, thus positioning the indicia 48 in a location where it will be frequently visible.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A telephone handset shoulder rest device configured to facilitate holding the telephone handset between a user's head and shoulder, the device comprising:
a) a spacing member, configured to be disposed on a back of a telephone handset, sized to facilitate holding the telephone handset between the user's head and shoulder;
b) an enlarged portion, forming at least a portion of an end of the spacing member, having a thickness with respect to the telephone handset greater than another portion of the spacing member;
c) a cushion, forming at least a portion of the spacing member, formed of a compliant material; and
d) the compliant material including a gel material.

2. A device in accordance with claim 1, further comprising:
a pair of at least semi-bulbous portions, forming at least a portion of opposite ends of the spacing member, and having substantially equal widths; and
a narrower neck, forming a portion of the spacing member between the pair of at least semi-bulbous portions, having a width less than the substantially equal widths of the pair of at least semi-bulbous portions, and having a thickness less than a thickness of the pair of at least semi-bulbous portions.

3. A device in accordance with claim 1, wherein the spacing member further includes:
a base, having the cushion thereon and configured to be disposed on the back of the telephone handset; and
the base being relatively more rigid with respect to the cushion, and the cushion being relatively more flexible with respect to the base.

4. A device in accordance with claim 1, wherein the cushion further includes:
an outer skin of thermo plastic urethane; and
an interior of polyurethane.

5. A device in accordance with claim 1, wherein the spacing member includes a translucent portion that is at least translucent; and further comprising:
indicia, disposed behind the translucent portion of the spacing member, and visible through the translucent portion of the spacing member.

6. A device in accordance with claim 5, wherein the spacing member includes a base; and wherein the indicia is disposed between the base and the translucent portion.

7. A device in accordance with claim 5, wherein the enlarged portion is at least semi-bulbous and corresponds to the translucent portion to alter a visual appearance of the indicia.

8. A device in accordance with claim 5, wherein the indicia is selected from the group consisting of: art work, a logo, an advertisement, an instruction, a brand, and a trademark.

9. A device in accordance with claim 1, further comprising:
affixing means, disposed on a back of the spacing member, configured for affixing the spacing member to a back of the telephone handset.

10. A device in accordance with claim 1, wherein the spacing member includes a base; wherein the base has one end thicker than another; and wherein the base has a back surface that is arcuate.

11. A telephone handset shoulder rest device configured to facilitate holding the telephone handset between a user's head and shoulder, the device comprising:
a) a spacing member, configured to be disposed on a back of a telephone handset, sized to facilitate holding the telephone handset between the user's head and shoulder;
b) an enlarged portion, forming a portion of the spacing member, having a thickness with respect to the telephone handset greater than another portion of the spacing member;
c) a translucent portion, forming at least a portion of the spacing member, being at least translucent; and
d) indicia, disposed behind the translucent portion of the spacing member, and visible through the translucent portion of the spacing member.

12. A device in accordance with claim 11, further comprising:
a cushion, forming a portion of the spacing member, formed of a compliant material.

13. A device in accordance with claim 12, wherein the compliant material includes a gel material.

14. A device in accordance with claim 13, wherein the cushion further includes:
an outer skin of thermo plastic urethane; and
an interior of polyurethane.

15. A device in accordance with claim 11, wherein the spacing member includes a base; and wherein the indicia is disposed between the base and the translucent portion.

16. A device in accordance with claim 11, wherein the enlarged portion is at least semi-bulbous and corresponds to the translucent portion to alter a visual appearance of the indicia.

17. A device in accordance with claim 11, wherein the indicia is selected from the group consisting of: art work, a logo, an advertisement, an instruction, a brand, and a trademark.

18. A device in accordance with claim 11, further comprising:
a pair of at least semi-bulbous portions, forming at least a portion of opposite ends of the spacing member, and having substantially equal widths; and
a narrower neck, forming a portion of the spacing member between the pair of at least semi-bulbous portions, having a width less than the substantially equal widths of the pair of at least semi-bulbous portions, and having a thickness less than a thickness of the pair of at least semi-bulbous portions.

19. A device in accordance with claim 11, wherein the spacing member further includes:
a base, having the translucent portion thereon and configured to be disposed on the back of the telephone handset; and
the base being relatively more rigid with respect to the translucent portion, and the translucent portion being relatively more flexible with respect to the base.

20. A device in accordance with claim 11, further comprising:
affixing means, disposed on a back of the spacing member, configured for affixing the spacing member to a back of the telephone handset.

21. A device in accordance with claim 11, wherein the spacing member includes a base; wherein the base has one end thicker than another; and wherein the base has a back surface that is arcuate.

22. A method for facilitating holding a telephone handset between a user's head and shoulder, and simultaneously promoting or providing information, comprising the steps of:
a) providing a telephone handset shoulder rest with a translucent portion, a cushion formed of a compliant material, and a bulbous portion;
b) providing indicia disposed under the translucent portion and visible therethrough, the indicia being indicative of a promotion or information; and
c) instructing to affix or affixing the telephone handset shoulder rest to a telephone handset.

23. A method in accordance with claim 22, wherein the step of providing indicia includes providing indicia is selected from the group consisting of: art work, a logo, an advertisement, an instruction, a brand, and a trademark.

24. A method in accordance with claim 22, wherein the cushion further includes an outer skin of thermo plastic urethane; and an interior of gel material including a polyurethane.
